(19) United States
(12) Patent Application Publication
(10) Pub. No.: US 2026/0039391 A1
(43) Pub. Date: Feb. 5, 2026

(54) MULTI-CHARACTERISTIC LASER PULSE COMMUNICATIONS

(71) Applicant: Aurelius Technologies Group, Inc., Layton, UT (US)

(72) Inventor: Ryan Welker, Layton, UT (US)

(73) Assignee: Aurelius Technologies Group, Inc., Layton, UT (US)

(21) Appl. No.: 19/285,936

(22) Filed: Jul. 30, 2025

Related U.S. Application Data
(60) Provisional application No. 63/677,956, filed on Jul. 31, 2024.

(51) Int. Cl. H04B 10/524; H04B 10/50

(52) U.S. Cl. CPC H04B 10/524; H04B 10/503

(57) ABSTRACT

Systems, methods, and devices are disclosed that can include an emitter device including an encoder configured to determine attributes of a laser pulse based on digital data, the attributes corresponding to a content of the digital data, and an emitter configured to generate the laser pulse having the determined attributes. The disclosed systems, methods, and devices can include a receiver device comprising one or more sensors configured to determine the attributes of the laser pulse, the attributes corresponding to a content of a message, the content of the message corresponding to a portion of the content of the digital data, and a decoder configured to use an encryption library to determine, based on the attributes of the laser pulse, the content of the message.

### CROSS-REFERENCE TO RELATED APPLICATIONS

This application claims the benefit of priority under 35 U.S.C. § 119(e) to U.S. Provisional Patent Application 63/677,956, titled “MULTI-CHARACTERISTIC LASER PULSE COMMUNICATIONS,” filed Jul. 31, 2024, which is hereby incorporated herein by reference in its entirety for all purposes.

### FIELD OF DISCLOSURE

The present disclosure is generally related to communication systems, devices, and methods, and more particularly to communication systems, devices, and methods utilizing lasers.

### BACKGROUND

Mass amounts of electronic data are being collected every day in nearly every country around the world. As an example, Internet searches, security camera footage, and GPS software help to create a picture of an individual's thoughts and actions throughout the course of their normal day. Accordingly, data on an individual can be stored and shared widely for various purposes. As another example, financial transaction data is increasingly voluminous as e-commerce continues to expand and proliferate. As another example, increasing quantities of sensitive healthcare data are being collected. In the information age, enterprises are amazing data for present or later analysis. Artificial intelligence (AI), and the heavy reliance on and use of data for training increasingly complex and proficient models, is fueling the capture and storage of data. Securely transmitting data can be difficult, requiring encryption technologies to prevent interception of the data and time to transmit the data. Malicious parties can intercept and attempt to decode encrypted data without alerting the attacked parties.

### SUMMARY

The present disclosure includes embodiments that provide for fast, secure transmission of data. Data can be encoded in multiple characteristics of a laser beam or laser pulse, including but not limited to color, polarization, intensity, duration, pulse shape, cross-section, power, energy, energy density, coherence length, beam profile, and divergence. By encoding data in multiple characteristics of a laser beam or laser pulse, information density can be increased, reducing transmission time. Moreover, encoding data in multiple characteristics of a laser beam or laser pulse allows for detection of attempts to intercept or interfere with the laser beam or laser pulse.

### BRIEF DESCRIPTION OF THE DRAWINGS

Illustrative embodiments will hereafter be described with reference to the accompanying drawings.

FIG. 1 is a block diagram illustrating an example system for transmission of encrypted data, in accordance with one or more embodiments.

FIG. 2 is a block diagram illustrating an example hub, in accordance with one or more embodiments.

FIG. 3 is a block diagram illustrating an example emitter device, in accordance with one or more embodiments.

FIG. 4 is a block diagram illustrating an example receiver device, in accordance with one or more embodiments.

FIG. 5 is a flow diagram illustrating example operations of a method to transmit encrypted information, in accordance with one or more embodiments.

FIG. 6 is a block diagram illustrating an example hub, in accordance with one or more embodiments.

FIG. 7 is a block diagram illustrating an example hub with dedicated transmission channels, in accordance with one or more embodiments.

FIG. 8 is a block diagram illustrating an example system for transmission of encrypted data between two computing systems, in accordance with one or more embodiments.

FIG. 9 is a diagram depicting an example environment of an example system for transmission of encrypted data, in accordance with one or more embodiments.

FIG. 10A is a block diagram illustrating an example repeater hub, in accordance with one or more embodiments.

FIG. 10B is a block diagram illustrating an example repeater hub, in accordance with one or more embodiments.

FIG. 11 is a block diagram illustrating an example destination hub, in accordance with one or more embodiments.

### DETAILED DESCRIPTION

Described herein are illustrative embodiments for methods and systems that provide for secure transmission of data with low transmission times and high detectability of interception attempts. Various embodiments described herein are directed to encoding data in multiple characteristics of a laser beam or laser pulse. By encoding data in multiple characteristics of a laser beam or laser pulse, interception and re-transmission of the laser beam or laser pulse is rendered practically impossible, as a time required for interception and re-transmission would delay the laser pulse by an amount of time sufficient to detect interception of the laser pulse. Furthermore, by encoding data in multiple characteristics of a laser beam or laser pulse, an information density of the laser beam or laser pulse is increased, reducing a transmission time for information encoded in the laser beam or laser pulse.

Devices for transmission of data encoded in multiple characteristics of a laser beam or laser pulse can include an emitter device to emit the laser beam or laser pulse and a receiver device to receive the laser beam or laser pulse. The emitter device can include an encoder to determine the multiple characteristics of the laser beam or laser pulse based on data to be transmitted. The receiver device can include one or more sensors to receive the laser beam or laser pulse and identify the multiple characteristics of the laser beam or laser pulse. The emitter device and the receiver device can be located within a same device or housing, where the laser beam or pulse travels within the housing. In other embodiments, the emitter device and receiver device can be separate from each other, such that the laser beam or laser pulse travels through open air.

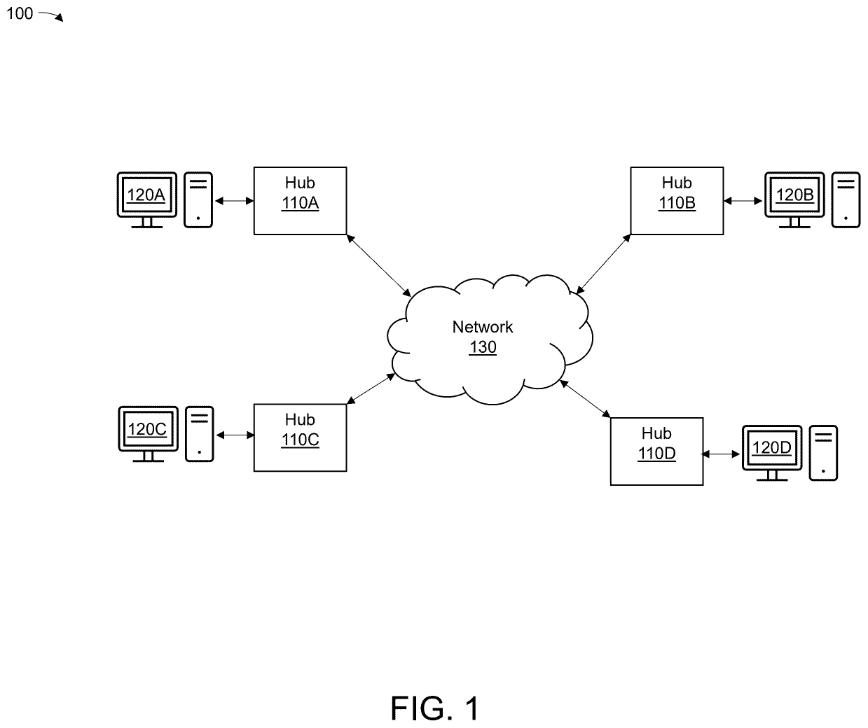

FIG. 1 is a block diagram illustrating an example system 100 for transmission of data in an encrypted manner, in accordance with one or more embodiments. The system 100 includes a first hub 110A associated with a first computing system 120A. The first hub 110A may encode data from the first computing system 120A in multiple characteristics of a laser beam or laser pulse. While various embodiments and examples refer to laser pulses, similar discussion applies to laser beams. The first hub 110A may exchange data via a network 130 to a second hub 110B associated with a second computing system 120B, a third hub 110C associated with a third computing system 120C, and a fourth hub 110D associated with a fourth computing system 120D. The first hub 110A, the second hub 110B, the third hub 110C, and the fourth hub 110D are referred to collectively herein as the hubs 110. The first computing system 110A, the second computing system 110B, the third computing system 110C, and the fourth computing system 110D are referred to collectively herein as the computing systems 120. The hubs 110 encode data on behalf of their respective computing systems.

In some implementations, the first hub 110A receives digital data from the first computing system 120A, encodes the digital data in multiple characteristics of a laser pulse, decodes the digital data from the multiple characteristics of the laser pulse, and transmits the decoded digital data to another hub of the hubs 110 via the network 130. In some implementations, the first hub 110A receives digital data from the first computing system 120A, encodes the digital data in multiple characteristics of a laser pulse, and transmits the laser pulse to another hub of the hubs 110, either directly or via the network 130 (e.g., fiber optic network). In this way, the laser pulse can provide data security and integrity within the first hub 110A and/or within the system 110 (i.e., between the hubs 110). In other words, the network 130 can be an existing network, such as a fiber optic network that is leveraged by the hubs 110 for transmitting data (e.g., encoded in laser pulses), and/or the network 130 can represent connections or transmission paths between the hubs 110. In some implementations, the network 130 is a combination of fiber optic cables and transmission paths between the hubs 110. Thus, the hubs 110 can communicate over an existing network and/or over open air using laser pulses.

The first hub 110A may use an encryption library to encode the digital data from the first computing system 120A in a message that can be decoded using the encryption library. The first hub 110A can encode the message in the laser pulse. Then, when the laser pulse is received, either within the first hub 110A or by another hub of the hubs 110, the laser pulse can be decoded to obtain the message, and the message can be decoded to obtain the digital data. In some implementations, the message may include a representation of discrete textual data mapped to a contextual map. In an example, visual representation of a plurality of discrete textual data include a separate color for each element within the discrete textual data, where contextual groupings are based on the separate colors. The encryption library can include a contextual map for mapping colors to textual data. Details on how digital data can be encoded in messages including color and other visual representations are provided in related U.S. Pat. No. 11,853,435, which is incorporated herein by reference in its entirety.

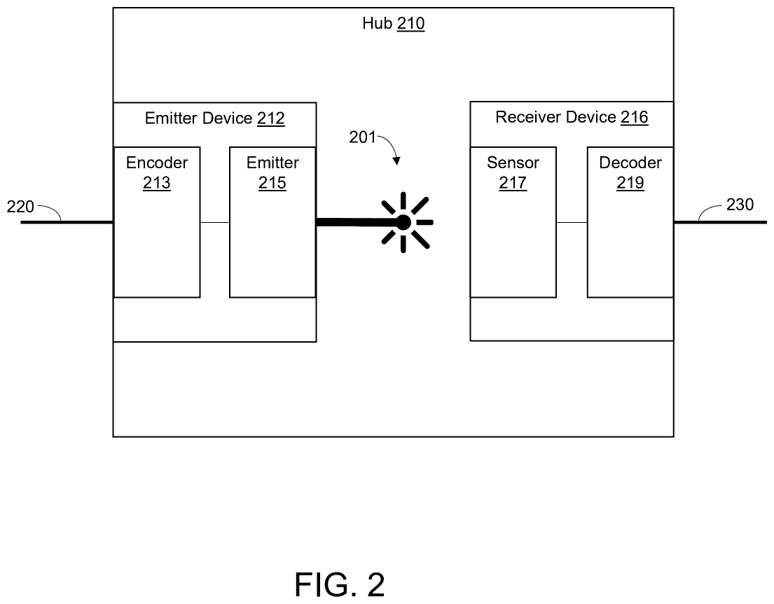

FIG. 2 is a block diagram illustrating an example hub 210, in accordance with one or more embodiments. The hub 210 includes an emitter device 212 and a receiver device 216. The hub 210 may be an example of a hub of the hubs 110 of FIG. 1.

The emitter device 212 includes an encoder 213 and an emitter 215. The emitter device 212 may receive digital data via a first connection 220 and emit a laser pulse 201 corresponding to the digital data. In some implementations, the laser pulse 210 includes a portion of the digital data encoded in attributes of the laser pulse 210. In some implementations, the laser pulse 210 includes a message based on the digital data encoded in attributes of the laser pulse 210.

The encoder 213 may be a hardware device configured to receive the digital data and determine attributes of the laser pulse 201 in order to encode the digital data in the laser pulse 201. The encoder 213 may receive the digital data and determine characteristics or attributes of the laser pulse 201 to be emitted. The encoder 213 may receive the digital data, perform calculations and/or mappings, and output the attributes. The encoder 213 may output the attributes of the laser pulse 201 to the emitter 215 in a digital signal. The encoder 213 may determine one or more attributes of the laser pulse 201 based on the digital data. In an example, the encoder 213 may determine a color and at least one additional attribute of the laser pulse 201 based on the digital data. The color and the at least one additional attribute correspond to a content of the digital data. As discussed above, the color can correspond to a visual representation of textual data. The encoder 213 may use a contextual mapping to map the content of the digital data to the color and the at least one additional attribute.

The emitter 215 may include hardware for emitting laser pulses with tunable attributes. In some implementations, the emitter 215 includes multiple lasers for emitting laser pulses with tunable attributes. In an example, the emitter 215 includes a red laser diode, a green laser diode, and a blue laser diode for emitting laser pulses having a variety of colors. The emitter 215 may include one or more lenses for adjusting attributes of the laser pulses In an example, the emitter 215 uses a first lens for a first laser pulse divergence and a second lens for a second laser pulse divergence. The emitter 215 can generate laser pulses with different colors, polarizations, intensities, durations, pulse shapes, cross-sections, power levels, energy levels, energy densities, coherence lengths, beam profiles, and/or divergences. The emitter 215 can generate laser pulses with any combination of attributes. The different colors or frequencies can span the visible light spectrum as well as beyond the visible light spectrum, including infrared, ultraviolet, and microwave. In some implementations, laser pulses in the X-ray, radio, and gamma ranges can be used. While various embodiments and examples herein are described in relation to lasers, other forms or descriptors for collimated, or highly-ordered light can be used, such as masers. The different polarizations can include any number of polarizations. The number of polarizations may depend upon a detectability of the different polarizations. In an example, the emitter 215 generates laser pulses of four different polarizations. In an example, the emitter 215 generates laser pulses of sixteen different polarizations. In an example, the emitter 215 generates laser pulses of one hundred and twenty eight different polarizations. The different intensities can include any number of intensities. The number of intensities may depend upon a detectability of the different intensities. The different durations can include any number of durations, such as a femtosecond duration, a picosecond duration, a nanosecond duration, or a millisecond duration. The different pulse shapes and beam profiles can include a wide variety of pulse shapes such as Lorentzian, hyperbolic secant, and flat-top. The different cross-sections can include a wide variety of cross-sections such as round, square, and triangular. The different power levels, energy levels, and energy densities can include any number of power levels, energy levels, and energy densities, dependent upon their detectability. The different coherence lengths can include any number of coherence lengths and the number of coherence lengths can depend upon a distance between the emitter 215 and the sensor 217 as well as usage of other attributes of the laser pulse 201. The different divergences can include any number of divergences allowed by a distance between the emitter 215 and the sensor 217. In some implementations, the encoder 213 also encodes data in attributes of sets of laser pulses, such as tempo and/or changes of attributes across the set of laser pulses, among other attributes.

The receiver device 216 may be a hardware device configured to receive the laser pulse 201, determine attributes of the laser pulse 201, and decode the attributes of the laser pulse 201 in order to obtain the digital data. The receiver device 216 may receive the laser pulse 201 and output the digital data, the portion of the digital data, or the message encoded in the laser pulse 201. The receiver device 216 may receive the laser pulse 201, perform calculations and/or mappings, and output the digital data. The receiver device 216 may use the same encryption library and/or mappings to decode the laser pulse as were used by the encoder 213 to encode the laser pulse 201. The receiver device 216 may output the digital data in a digital signal via the second connection 230. The receiver device 216 includes a sensor 217 and a decoder 219.

The sensor 217 is one or more hardware sensors to receive the laser pulse 201 and identify the attributes of the laser pulse 201. The sensor 217 may be a single sensor to receive and determine multiple attributes of laser pulses, or a sensor array to receive and determine multiple attributes of laser pulses. In an example, the sensor 217 includes an array of sensors, where each sensor of the array of sensors is to detect a different attribute. The sensor 217 may be configured to detect and determine attributes the encoder 213 uses for encoding and which can be included in the laser pulse 201 the emitter 215 emits. In this way, the sensor 217 may match a complexity of the emitter 215 such that the sensor 217 is able to detect at least as many attributes of laser pulses as the emitter 215 is capable of imparting to generated laser pulses. In this way, the sensor 217 is able to detect the attributes of the laser pulse generated by the emitter 215.

The decoder 219 may be hardware configured to receive the determined attributes from the sensor 217 and decode the received attributes. The decoder 219 may receive the attributes of the laser pulse 201 and decode the attributes to determine the digital data, the portion of the digital data, or the message encoded in the laser pulse 201 (generally referred to as the digital data). The decoder 219 may receive the attributes, perform calculations and/or mappings, and output the digital data. The decoder 219 may output the digital data in a digital signal via the second connection 230. In an example, the second connection 230 is a fiber optic cable. The decoder 219 may use a contextual mapping to map the attributes of the laser pulse 201 (e.g., color and at least one additional attribute) to the content of the digital data.

In some implementations, the hub 210 receives the digital data via the first connection 220 in the form of a laser pulse, similar to the laser pulse 201. In an example, the first connection 220 is a fiber optic cable and the digital data is received as an infrared laser pulse through the fiber optic cable. The hub 210 may include a second receiver device for receiving and decoding the laser pulse received via the first connection 220. The laser pulse received via the first connection 220 may have different attributes than the laser pulse 201. Alternatively, the laser pulse received via the first connection 220 may have some or all of the same attributes as the laser pulse 201.

In some implementations, the hub 210 transmits the digital data via the second connection 230 in the form of a laser pulse, similar to the laser pulse 201. In an example, the second connection 230 is a fiber optic cable and the digital data is transmitted as an infrared laser pulse through the fiber optic cable. The hub 210 may include a second emitter device for encoding and emitting the laser pulse through the second connection 230. The laser pulse transmitted via the second connection 230 may have different attributes than the laser pulse 201. In this way, the hub 210 can translate data between different encoding paradigms (i.e., using different encryption libraries) using different attributes for encoding. In an example, the hub 210 receives an infrared laser pulse via the first connection 220, generates the laser pulse 201 in the visible spectrum, and transmits another infrared laser pulse via the second connection 230.

The hub 210 can receive and transmit data bidirectionally. In some implementations, the hub 210 receives data via the second connection 230, routes the data to the emitter device 212 which transmits the data, encoded in the laser pulse 201, to the receiver device 216 which transmits the data via the first connection 220. In some implementations, the hub 210 includes a dedicated channel for different directions of communications. In an example, the hub 210 includes a second emitter device and a second receiver device for receiving data via the second connection 230 and transmitting data via the first connection 220. In some implementations, the hub 210 uses different encoding schema for transmitting data in different directions. In this way, transmissions in one direction (i.e., laser pulses going in one direction) cannot be decoded using an encryption library for another direction of transmission.

In another embodiment, the hub 210 is a bidirectional transceiver that can receive digital data (e.g., in the form of an incoming laser pulse) via the first connection 220 or the second connection 230 and then transmit the digital data (e.g., in the form of an outgoing laser pulse) via the other of the first connection 220 or the second connection 230. The incoming laser pulse may have different attributes than the attributes of the outgoing laser pulse. Alternatively, the incoming laser pulse may have some or all of the same attributes as the outgoing laser pulse (e.g., the hub 210 may operate as or perform the function(s) of a repeater).

In such embodiment the hub 210 may or may not include an internal transmission of the digital data via the laser pulse 201.

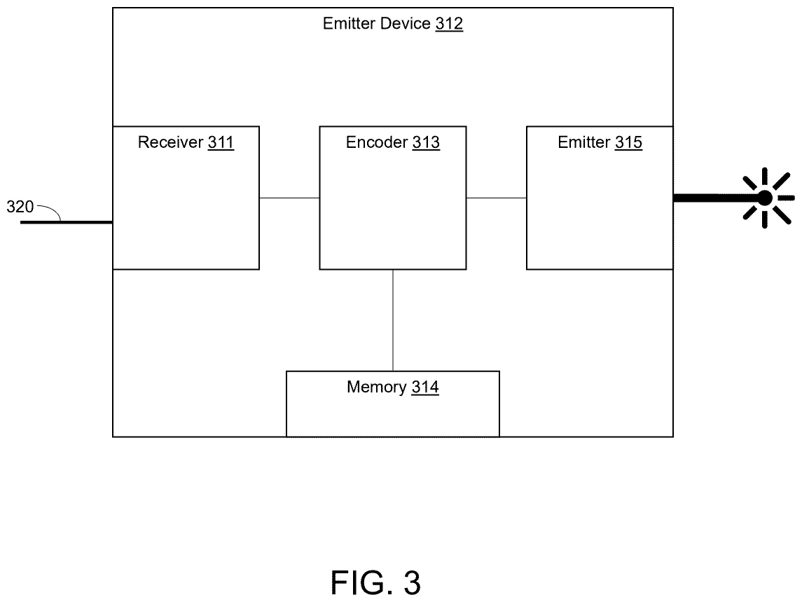

FIG. 3 is a block diagram illustrating an example emitter device 312, in accordance with one or more embodiments. The emitter device 312 may be an example of the emitter device 212 of FIG. 2. The emitter device 312 may be part of a hub such as the hub 210 of FIG. 2.

The emitter device 312 includes a receiver 311, an encoder 313, a memory 314, and an emitter 315. The receiver 311 may be hardware configured to receive a digital signal including digital data via a first connection 320. In an example, the receiver 311 is a fiber-optic receiver configured to receive an infrared signal including the digital data. In an example, the receiver 311 is a processor or decoder configured to receive an electrical signal including the digital data. The receiver 311 provides the digital data to the encoder 313. The encoder 313 determines two or more attributes (e.g., color and another attribute) of a laser pulse to be generated by the emitter 315 based on the digital data to encode the digital data, or a message corresponding to the digital data, in the laser pulse. The encoder 313 can access the memory 314 to determine the two or more attributes of the laser pulse. The memory 314 may include a non-transitory, computer-readable medium including an encryption library and/or instructions to encode information in laser pulses. In some implementations, the encoder 313 uses the encryption library to map a content of the digital data to attributes (e.g., color and at least one additional attribute) of the laser pulse. The encoder 313 may encode the digital data or a portion of the content of the digital data in a message corresponding to a contextual mapping. The encoder 313 can encode the message in the laser pulse using the encryption library. In this way, when the laser pulse is received, its attributes can be decoded to determine the message, and the message can be decoded, using the encryption library, to determine the digital data. In some implementations, the memory 314 includes a mapping of laser pulse attributes to information for encoding messages in laser pulses.

In some implementations, the encoder 313 determines, based on the digital data, a number of attributes to use in encoding the digital data in the laser pulse. The emitter 315 may have a set of default attributes that do not carry meaning, where variation from a default attribute corresponds to encoded information. By determining the number of attributes used to encode the digital data, the encoder 313 can adjust an information density of the laser pulse based on the digital data. In an example, the encoder 313 determines that four attributes of the laser pulse will be adjusted (e.g., away from default values) such that a color, a polarization, a beam profile, and a pulse shape of the laser pulse are adjusted to encode the digital data in the laser pulse.

In some implementations, the encoder 313 generates multiple messages based on the same digital data. In an example, a first message based on the digital data may include a first level of detail and a second message based on the digital data may include a second level of detail that is less than the first level of detail. The encoder 313 may determine different attributes and/or different numbers of attributes for encoding the first and second messages in laser pulses. In an example, the encoder 313 determines a first set of attributes (e.g., color and at least one additional attribute) for encoding the first message in a first laser pulse and a second set of attributes (e.g., color and at least one additional attribute) having a fewer number of attributes than the first set of attributes for encoding the second message in a second laser pulse. In this way, the encoder 313 can encode different amounts of information in different laser pulses based on the same digital data.

In some implementations, the memory 314 includes a plurality of encryption libraries. The encoder 313 may select an encryption library from the plurality of encryption libraries for encoding digital data in laser pulses. In some implementations, the plurality of encryption libraries correspond to different recipients of the laser pulse. The encoder 313 can select an encryption library based on a recipient of the laser pulse, where the recipient has a copy of the same encryption library for decoding the laser pulse. In this way, only the recipient (i.e., intended recipient) can decode the laser pulse using the same encryption library used to encode the laser pulse.

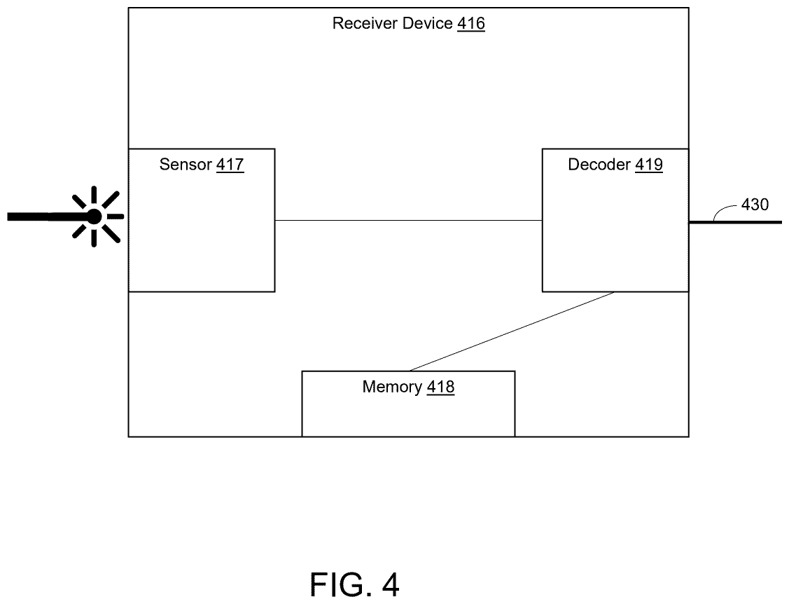

FIG. 4 is a block diagram illustrating an example receiver device 416, in accordance with one or more embodiments. The receiver device 416 may be an example of the receiver device 216 of FIG. 2. The receiver device 416 may be part of a hub, such as the hub 210 of FIG. 2.

The receiver device 416 includes a sensor 417, a memory, 418, and a decoder 419. The sensor 417 may include one or more sensors to receive laser pulses and determine attributes of the laser pulses. The sensor 417 is one or more hardware sensors to receive laser pulses and identify attributes of the laser pulses. The sensor 417 may be a single sensor to receive and determine multiple attributes of laser pulses, or a sensor array to receive and determine multiple attributes of laser pulses. The decoder 419 may be hardware configured to receive the determined attributes from the sensor 417 and decode the received attributes. The decoder 419 may receive the attributes of the laser pulses and decode the attributes to determine digital data encoded in the laser pulses. The decoder 419 may include one or more processors for decoding the received attributes. The sensor 417 may be an example of the sensor 217 of FIG. 2. The decoder 419 may be an example of the decoder 219 of FIG. 2.

The decoder 419 accesses the memory 418 to decode the attributes of the laser pulses. The memory 418 may include a non-transitory, computer-readable medium including mappings, an encryption library, and/or instructions which are executed by the decoder 419 to decode the attributes of the laser pulses. The decoder 419 may use the encryption library to map the laser pulse attributes to a content of the digital data and/or to a message which maps to the content of the digital data. The encryption library may be the same as an encryption library that was used to generate the laser pulses. The memory 418 may include a single encryption library or multiple encryption libraries. In an example, the memory 418 includes a single encryption library, and the receiver device 416 decrypts laser pulses encoded using the single encryption library. In an example, the memory 418 includes multiple encryption libraries, and the receiver device selects an encryption library from the multiple encryption libraries based on one or more attributes of laser pulses.

The decoder 419 may compare attributes of a received laser pulse to default attributes to determine which attributes are used to encode the digital data or the message. In this way, the decoder 419 can determine a number of attributes that are used to encode the message, and which attributes are used to encode the message. In an example, the decoder 419 receives a laser pulse having a color and ten additional attributes, three of which differ from default values. In this example, the decoder 419 compares the ten additional attributes to default values to determine that only three of the ten additional attributes are used to encode information in the laser pulse. In this example, the decoder 419 maps the three additional attributes departing from default values to a message and uses the encryption library in the memory 418 to decrypt the message.

In some implementations, a color of a laser pulse corresponds to a starting point in the encryption library and another attribute of the laser pulse corresponds to a modification of the starting point in the encryption library. Additional attributes of the laser pulse can correspond to additional modifications to the starting point in the encryption library. In some implementations, the decoder 419 maps the laser pulse attributes to a message including the starting point and the modifications to the starting point which can be applied to the encryption library to decode the message. The decoder 419 can use the attributes of the laser pulse to define a path within the encryption library to decode the laser pulse. Each step along the path within the encryption library (i.e., each modification to the starting point) can unfold additional encrypted information encoded in the laser pulse. Described differently, the decoder 419 can unfold the message using the encryption library, where the encryption library includes information of the unfolded message. In some implementations, each modification to the starting point within the encryption library corresponds to a different level of detail of the message. In an example, the starting point may indicate a person has a favorite baseball team, a first modification indicates that the person's favorite baseball team is a west coast team, a second modification indicates that the person's favorite baseball team is in a specific league on the west coast, and a third modification indicates that the person's favorite baseball team is a specific team in the specific league on the west coast. As discussed herein, multiple different laser pulses can be encoded with different messages based on the same digital data. Following the example above, a first message may indicate that the person's favorite baseball team is a west coast team and a second message may indicate that the person's favorite baseball team is the specific team in the specific league on the west coast.

The decoder 419 may output a digital signal including the digital data or a message corresponding to a portion of the digital data via a second connection 430. The second connection 430 may be an electrical connection to a computing system, such as a computing system of the computing systems 120 of FIG. 1. In some implementations, the second connection 430 is a fiber optic cable.

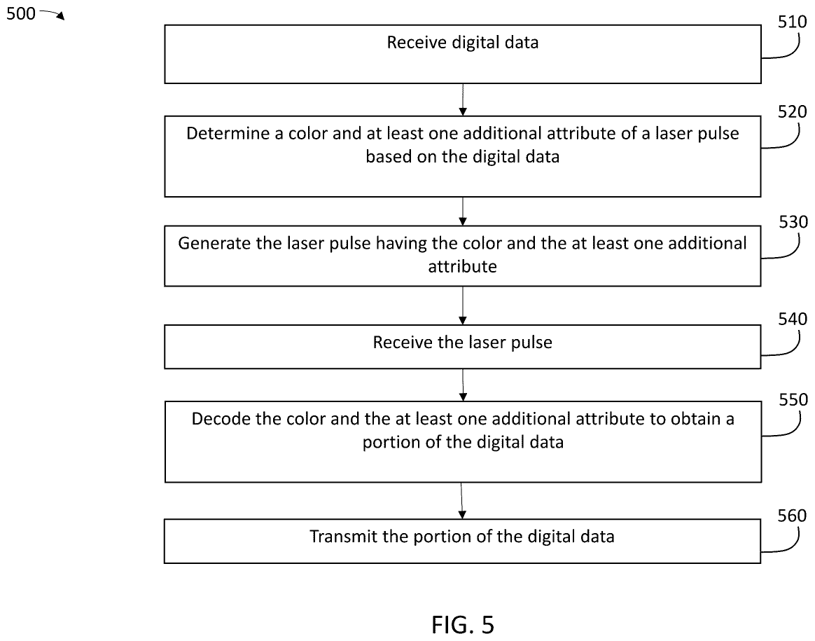

FIG. 5 is a flow diagram illustrating example operations of a method 500 to transmit encrypted information. The method 500 may include more, fewer, or different operations than illustrated. The operations may be performed in the order shown, in a different order, or concurrently.

At operation 510, digital data is received. The digital data can be received at a hub, such as the hub 210 of FIG. 2. The digital data can be received from a computing system, such as the first computing system 120A of FIG. 1. The digital data may include any form of structured or unstructured data, including textual, numerical, or multimedia content, and may be received via a wired or wireless interface, such as a fiber optic cable.

At operation 520, a color and at least one additional attribute of a laser pulse are determined based on the digital data. The color and the at least one additional attribute are determined by encoding a portion of the digital data or a message corresponding to the portion of the digital data in the color and the at least one additional attribute. In this way, the digital data (e.g., portion of the digital data, message encoding the portion of the digital data) is encoded in the color and the at least one additional attribute. The digital data can be encoded in the color and the at least one additional attribute using an encryption library which maps the digital data to the color and the at least one additional attribute.

At operation 530, a laser pulse is generated having the color and the at least one additional attribute. The laser pulse can have multiple other attributes. The at least one additional attribute can be distinguished from other, non-information-bearing attributes of the laser pulse by differing from a default value. In an example, a default pulse shape may be Gaussian, and the pulse shape can be used to encode information by differing from the default Gaussian shape.

At operation 540, the laser pulse is received. The laser pulse can be received by one or more sensors. The one or more sensors can determine the attributes of the laser pulse. The one or more sensors can determine which attributes of the laser pulse encode information based on deviation from default values. In some implementations, color is always used to encode information, with additional attributes of the laser pulse used to encode additional information.

At operation 550, the color and the at least one additional attribute are decoded to obtain a portion of the digital data. The decoder uses the encryption library to map the detected attributes to a message or directly to the original digital data. In some implementations, the color and the at least one additional attribute are mapped to components of a message and the message is applied to an encryption library to decode the message to obtain the portion of the digital data.

At operation 560, the portion of the digital data is transmitted. In some implementations, the laser pulse is generated and received within a single device, such as the hub 210 of FIG. 2. In some implementations, the laser pulse is generated by a first device and received by a second device remote from the first device. In this way, a spatial gap between the generation of the laser pulse and the reception of the laser pulse can be any length, whether within a single device or between multiple devices. In some embodiments, the decoded data may be re-encoded into a new laser pulse with different attributes for further transmission, enabling multi-hop secure communication.

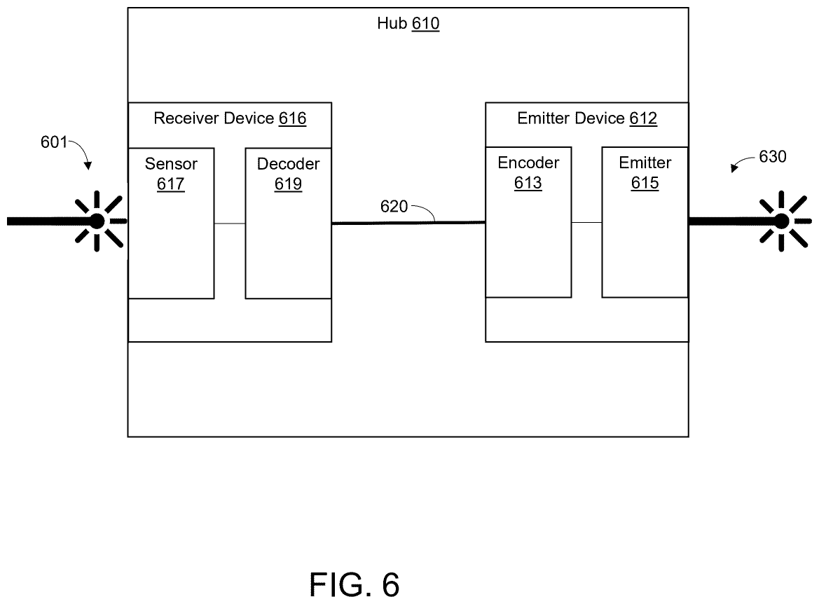

FIG. 6 is a block diagram illustrating an example hub 610, in accordance with one or more embodiments. The hub 610 is similar to the hub 210 of FIG. 2, except that the hub 610 receives a first laser pulse 601 from outside the hub 610 and emits a second laser pulse 630. The hub 610 may operate as or perform the function(s) of a repeater.

The hub 610 includes a receiver device 616 including a sensor 617 and a decoder 619. The hub 610 includes an emitter device 612 including an encoder and an emitter 615. The sensor 617 receives the first laser pulse 601, the decoder 619 decodes attributes of the first laser pulse 601 to obtain a message or digital data, and transmits the message or digital data via a connection 620 to the emitter device 612. In some embodiments, the decoder 619 and the encoder 613 are directly connected and/or integrated. In some embodiments, the connection 620 is a trace, wire, or other electrical connection. The encoder 613 encodes the message or digital data in attributes of the second laser pulse 630 and the emitter 615 emits the second laser pulse 615 having the attributes determined by the encoder 613. The attributes of the first laser pulse 601 may be different from the attributes of the second laser pulse 630. In this way, the hub 610 may change the encryption of the message or digital data. In an example, the hub 610 translates the message from a first encryption represented in the first laser pulse to a second encryption represented in the second laser pulse 630.

In some implementations, the hub 610 provides the message or digital data to a computing system via the connection 620. The computing system can provide instructions to the emitter device 612 to emit the second laser pulse 630 based on the message or digital data. In this way, the hub 610 receives and decodes laser pulses on behalf of the computing system and encodes and emits laser pulses on behalf of the computing system to allow the computing system to communicate using securely encrypted laser pulses. The hub 610 may be an example of the hubs 110 of FIG. 1, where the computing systems 120 are able to securely communicate using data encoded in laser pulses.

In some implementations, the hub 610 does not include the receiver device 616 and the hub 610 receives the message or digital data via the connection 620 from a computing system. In this way, the hub 610 serves to encode the message or digital data in the second laser pulse 630 for secure transmission.

In some implementations, the hub 610 does not include the emitter device 612 and the hub 610 provides the message or digital data via the connection 620 to a computing system. In this way, the hub 610 serves to receive and decode data encoded in the first laser pulse 601 on behalf of the computing system, allowing for reception and decoding of data securely transmitted in the first laser pulse 601.

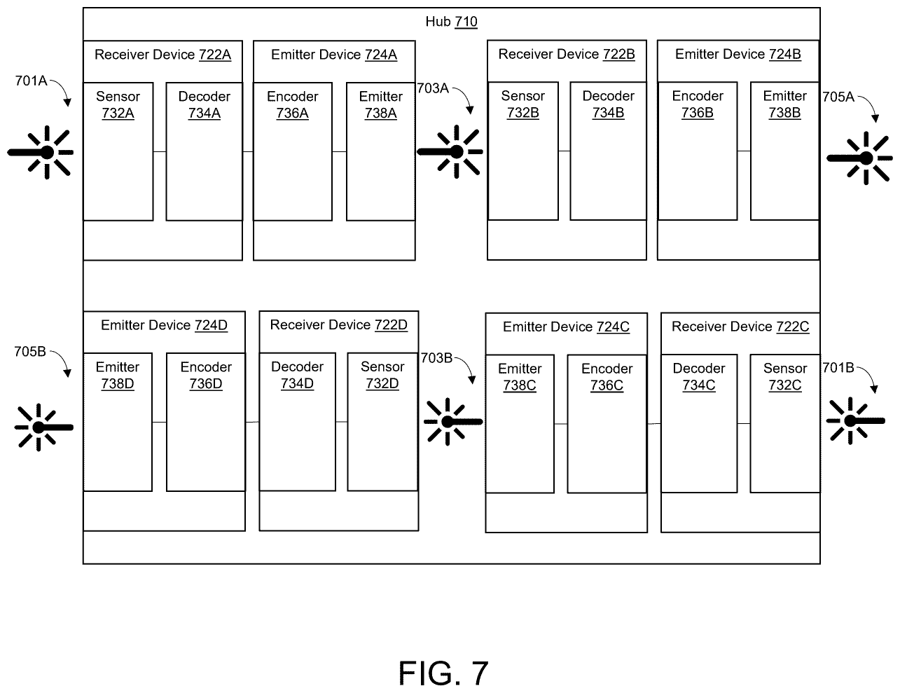

FIG. 7 is a block diagram illustrating an example hub 710 with dedicated transmission channels, in accordance with one or more embodiments. The hub 710 includes a first receiver device 722A, a first emitter device 724A, a second receiver device 722B, and a second emitter device 724B. The first receiver device 722A, the first emitter device 724A, the second receiver device 722B, and the second emitter device 724B form a first transmission channel for receiving laser pulses and transmitting laser pulses in a first transmission direction. The first receiver device 722A includes a first sensor 732A for receiving a first laser pulse 701A and a first decoder 734A for decoding the first laser pulse 701A. The first emitter device 724A includes a first encoder 736A for encoding the decoded data from the first receiver device 722A into second laser pulse attributes and a first emitter 738A for generating a second laser pulse 703A having the second laser pulse attributes. The second receiver device 722B includes a second sensor 732B for receiving the second laser pulse 703A and a second decoder 734B for decoding the second laser pulse 703A. The second emitter device 724B includes a second encoder 736B for encoding the decoded data from the second receiver device 722B into third laser pulse attributes and a second emitter 738B for generating a third laser pulse 705A having the third laser pulse attributes.

The first laser pulse 701A may have different attributes than the second laser pulse 703A and/or the third laser pulse 705A. In some implementations, the first laser pulse 701A, the second laser pulse 703A, and/or the third laser pulse 705A may have one or more attributes in common. In some implementations, the second laser pulse 703A has a different number of attributes used for encoding data than the first laser pulse 701A and the third laser pulse 705A. In an example, the first laser pulse 701A is an infrared laser pulse transmitted via a fiber optic cable having data encoded in three attributes, the second laser pulse 703A is a visible light laser pulse transmitted over open air having data encoded in eight attributes, and the third laser pulse 705A is an infrared laser pulse transmitted via a fiber optic cable having data encoded in three attributes. In this example, the first laser pulse 701A can be the same as the third laser pulse 705A, or the first laser pulse 701A can be different from the third laser pulse 705A. If the first laser pulse 701A and the third laser pulse 705A are different, the hub 710 can translate between different encoding paradigms.

The hub 710 includes a third receiver device 722C, a third emitter device 724C, a fourth receiver device 722D, and a fourth emitter device 724D. The third receiver device 722C, the third emitter device 724C, the fourth receiver device 722D, and the fourth emitter device 724D form a second transmission channel for receiving laser pulses and transmitting laser pulses in a second transmission direction. The third receiver device 722C includes a third sensor 732C for receiving a fourth laser pulse 701B and a third decoder 734C for decoding the fourth laser pulse 701B. The third emitter device 724C includes a third encoder 736C for encoding the decoded data from the third receiver device 722C into fifth laser pulse attributes and a third emitter 738C for generating a fifth laser pulse 703B having the fifth laser pulse attributes. The fourth receiver device 722D includes a fourth sensor 732D for receiving the fifth laser pulse 703B and a fourth decoder 734D for decoding the fifth laser pulse 703B. The fourth emitter device 724D includes a fourth encoder 736D for encoding the decoded data from the fourth receiver device 722D into sixth laser pulse attributes and a fourth emitter 738D for generating a sixth laser pulse 705B having the sixth laser pulse attributes.

The first transmission channel and the second transmission channel can use different encryption paradigms for receiving and transmitting laser pulses. The first transmission channel and the second transmission channel can use similar or even identical encryption paradigms for receiving and transmitting laser pulses. The hub 710 can include any number of transmission channels for receiving and transmitting laser pulses. In some implementations, the hub 710 includes additional transmission channels for different senders, recipients, types of laser pulses, and/or encryption paradigms.

In some implementations, the hub 710 serves as an intermediary (e.g., a repeater hub) for other hubs for transmitting data between computing devices. In an example, a first hub generates the first laser pulse 701A based on data received from a first computing system and a second hub receives the third laser pulse 705A to deliver data to a second computing system. The second hub can generate the fourth laser pulse 701B based on data form the second computing system and the first hub can receive the sixth laser pulse 705B. In this way, the hub 710 can translate between a first encryption paradigm used by the first computing system and a second encryption paradigm used by the second computing system.

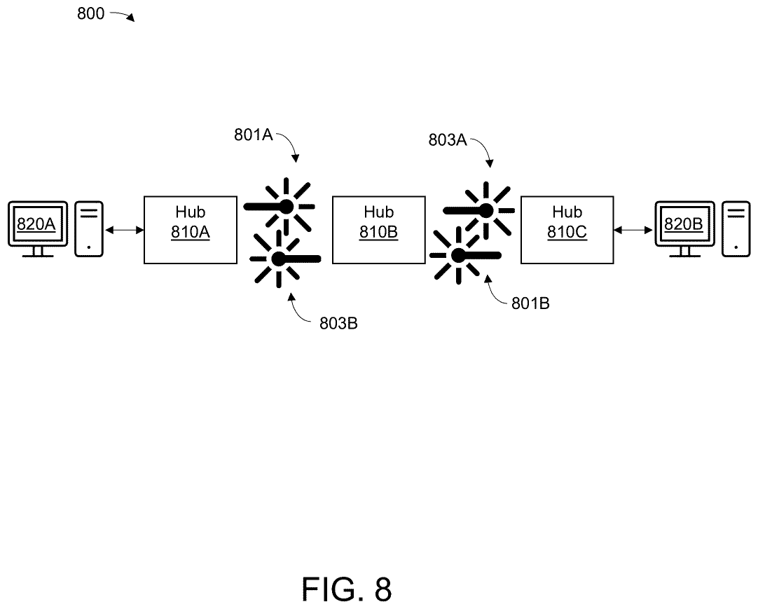

FIG. 8 is a block diagram illustrating an example system 800 for transmission of encrypted data between two computing systems, in accordance with one or more embodiments. The system 800 includes a first computing system 820A and a second computing system 820B. The first computing system 820A can be a standalone computing system. In another embodiment, the first computing system 820A can be a computing system of a data center. The second computing system 820B can be a standalone computing system. In another embodiment, the second computing system 820B can be a computing system of a data center. The system 800 includes a first hub 810A, a second hub 810B, and a third hub 810C, referred to collectively herein as hubs 810.

The first hub 810A receives digital data from the first computing system 820A and generates a first laser pulse 801A based on the digital data, where the digital data is encoded in attributes of the first laser pulse 801A, as discussed herein. The first hub 810A can be a destination hub, or an endpoint hub, which couples to a computing system (e.g., the first computing system 820A) or otherwise couples to a wired connection or other connection that is other than a laser pulse. The connection between the first computing system 820A and the hub 810A may be a single channel connection (e.g., a single wire connection or single port connection). In another embodiment, the connection between the first computing system 820A and the hub 810A may be a multiple channel connection (e.g., n-wire connection, n-port connection). The hub 810A can operate to receive n inputs and transform the data of the n inputs into a single laser pulse 801A.

The second hub 810B receives the first laser pulse 801A and generates a second laser pulse 803A. The second laser pulse 803A can include or otherwise be based on the data encoded in the first laser pulse 801A. The second hub 810B can be a repeater hub. The second hub 810B may use a different encryption paradigm (e.g., encryption library, attributes used for encryption, number of attributes used for encryption) for generating the second laser pulse 803A than was used by the first hub 810A in generating the first laser pulse 801A. In some implementations, the second hub 810B generates an intermediate laser pulse, as illustrated in FIG. 7.

The third hub 810C receives the second laser pulse 803A, decodes the data encoded in the second laser pulse 803A, and transmits the decoded data to the second computing system 820B. The third hub 810C can be a destination hub, or an endpoint hub, which couples to a computing system (e.g., the first computing system 820A) or otherwise couples to a wired connection or other connection that is other than a laser pulse. The connection between the second computing system 820B and the hub 810C may be a single channel connection (e.g., a single wire connection or single port connection). In another embodiment, the connection between the second computing system 820B and the hub 810C may be a multiple channel connection (e.g., n-wire connection, n-port connection). The hub 810C can operate to receive a single laser pulse (e.g., the second laser pulse 803A) as an input and to transmit the decoded data to the second computing device 820B.

The third hub 810C can also receive digital data from the second computing system 820B and can encode the received digital data in a third laser pulse 801A. The second hub 810B receives the second laser pulse 801A and generates a fourth laser pulse 803B. The first hub 810A receives the fourth laser pulse 803B and decodes the fourth laser pulse 803B to transmit the decoded data to the first computing device 820A.

In this way, the first computing system 820A can securely send messages to and receive messages from the second computing system 820B. If any of the laser pulses are intercepted, the information will still be protected, as the laser pulses cannot be decrypted without the corresponding encryption libraries. Furthermore, the system 800 can monitor a timing of when laser pulses are sent to determine whether laser pulses arrive when they are expected to arrive, preventing interception and retransmission of the laser pulses. The second hub 810B may form part of a network between a plurality of computing devices, such as the network 130 of FIG. 1. In addition, environmental factors may impact performance, such as weather, distance, or the like. Weather could impact satellite connectivity for laser connection, in which case communication may be routed to fiber optic only routing.

In some implementations, the second hub 810B does not decode the first laser pulse 801 and the third laser pulse 801A. The second hub 810B can map attributes of the first laser pulse 801 to attributes of the second laser pulse 803A and map attributes of the third laser pulse 801A to attributes of the fourth laser pulse 803B without decoding the first laser pulse 801 and the third laser pulse 801A. In this way, the digital data is in its decoded form within the hubs 810 only at the first hub 810A and the third hub 810C, preventing access to the data within the second hub 810B.

In some implementations, the second hub 810B generates a verification notification that the first laser pulse 801 was received at the second hub 810B and that the first laser pulse 801 matches an encryption paradigm used by the first hub 810A. In this way, the second hub 810B can provide verification of an intermediate stage of transmission of the data that was encoded in the first laser pulse 801. The system 800 can include a plurality of hubs for exchanging laser pulses. In some implementations, each hub of the plurality of hubs generates a verification notification to construct a verification ledger (or code) indicating that laser pulses were successfully transmitted between the plurality of hubs. In this way, a laser pulse received at the second computing system 820B can be verified, using the verification ledger, as originating as data from the first computing system.

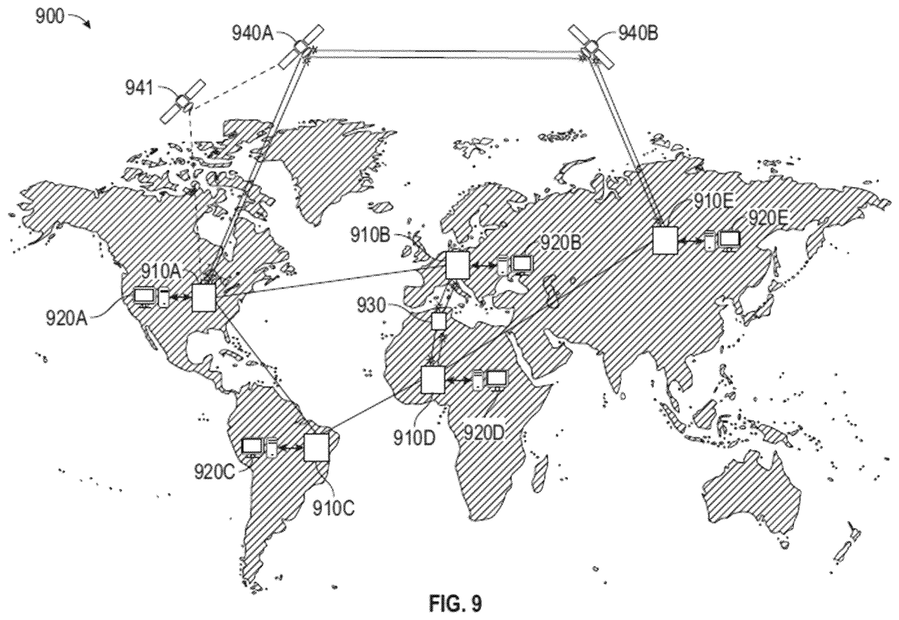

FIG. 9 is a diagram illustrating an example system 900 for transmission of encrypted data, in accordance with one or more embodiments, and depicting a global environment in which such example system 900 may operate. The system 900 includes a plurality of destination hubs 910A, 910B, 910C, 910D, 910E (collectively or individually hub(s) 910), a plurality of computing systems 920A, 920B, 920C, 920D, 920E (collectively or individually computing system(s) 920), one or more repeater hubs 930, and one or more satellite hubs 940A, 940B (collectively or individually satellite hub(s) 940). The system 900 can include dedicated and/or existing infrastructure, such as fiberoptic cable, computing systems, communication devices (e.g., satellite(s) 941), and the like.

The hubs 910 may provide decoded (e.g., decrypted) data to a corresponding computing system 920. The hubs 910 may also receive data from a corresponding computing system 920 and encode (e.g., encrypt) the data (e.g., using attributes of a laser pulse) for transmission in a form of a laser pulse to another hub 910, 930, 940. The hubs 910 interconnect via connections, which may form a communication network, according to embodiments of the present disclosure, including fiber optic cable (existing infrastructure, new dedicated infrastructure) and wireless connection by transmission of data directly through the environment (e.g., open air). The hubs 910, 930, 940 communicate over the communication network by laser pulse, for example an infrared laser pulse, such as in the manner described in the foregoing discussion. In an example, a first laser pulse is an infrared laser pulse transmitted from a first hub 910A to a second hub 910B through fiber optic cable. The fiber optic cable may include one or more fiber optic cables of an existing fiber optic network or other fiber optic infrastructure. Alternatively or in addition, the fiber optic cable may include one or more dedicated fiber optic cables, such as may be newly installed to facilitate transmission of data between hubs 910, 930 940. The first laser pulse may have data encoded, for example, in three attributes of the first laser pulse. In another example, a second laser pulse can be a visible light laser pulse transmitted over open air from a first hub 910A to a first satellite hub 940A. The second laser pulse may have data encoded, for example, in five attributes of the second laser pulse.

The destination hubs 910 can couple to and/or communicate with a computing system (e.g., the first computing system 820A of FIG. 8) or otherwise couple to and transmit along a wired connection or other connection that is other than a laser pulse.

The repeater hub(s) 930 may simply forward received transmissions as new forwarded transmissions. The received transmissions may be a laser pulse received via a fiber optic connection or through an open-air transmission. The repeater hub(s) 930 may optionally re-encode (e.g., re-encrypt, according to different attributes from the received laser pulse.) The forwarded transmissions may be provided by a laser pulse via fiber optic cable and/or through an open-air transmission.

The satellite hub(s) 940 may orbit the earth to provide line of site access to any hub 910 located at any position on the earth, thereby facilitating open-air transmission of data via laser pulse in a manner as previously described. The satellite hub(s) 940 may, in some embodiments, be repeater hubs that receive a transmission and then retransmit (or forward) the transmission to another hub 910, 930, 940. The retransmission may include re-encoding using different attributes of a laser pulse. The satellite hub(s) 940 may, in other embodiments, include computing resources, such as a classical computing device or quantum computing device, which may operate (e.g., cooled) more effectively in lower temperatures of the upper atmosphere and/or outer space.

In another example, the system 900 can also communicate with existing satellite(s) 941 and other communication devices (e.g., cell towers, wireless access points) using existing protocols.

In the example of FIG. 9, the system 900 is a global data transmission system for transmitting data to locations (e.g., on multiple continents) throughout the world. This example global data transmission system 900 is illustrative of one configuration and is nonlimiting. Stated otherwise, the system 900 could have any appropriate combination or arrangement of hubs 910, repeater hubs 930, and satellite hubs 940.

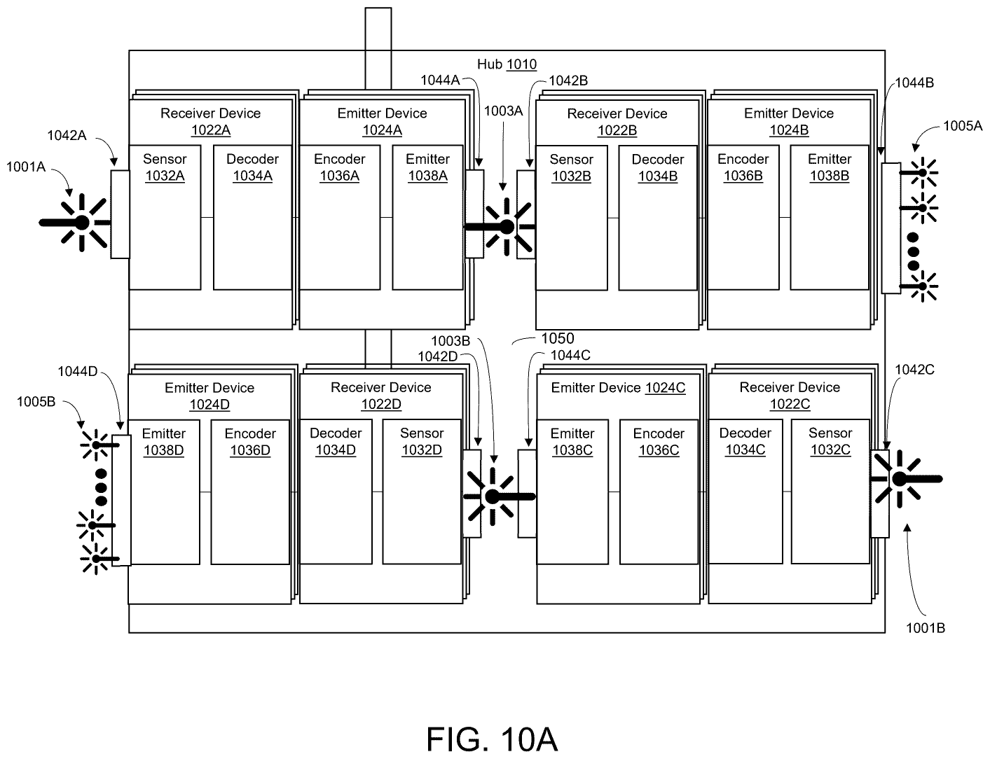

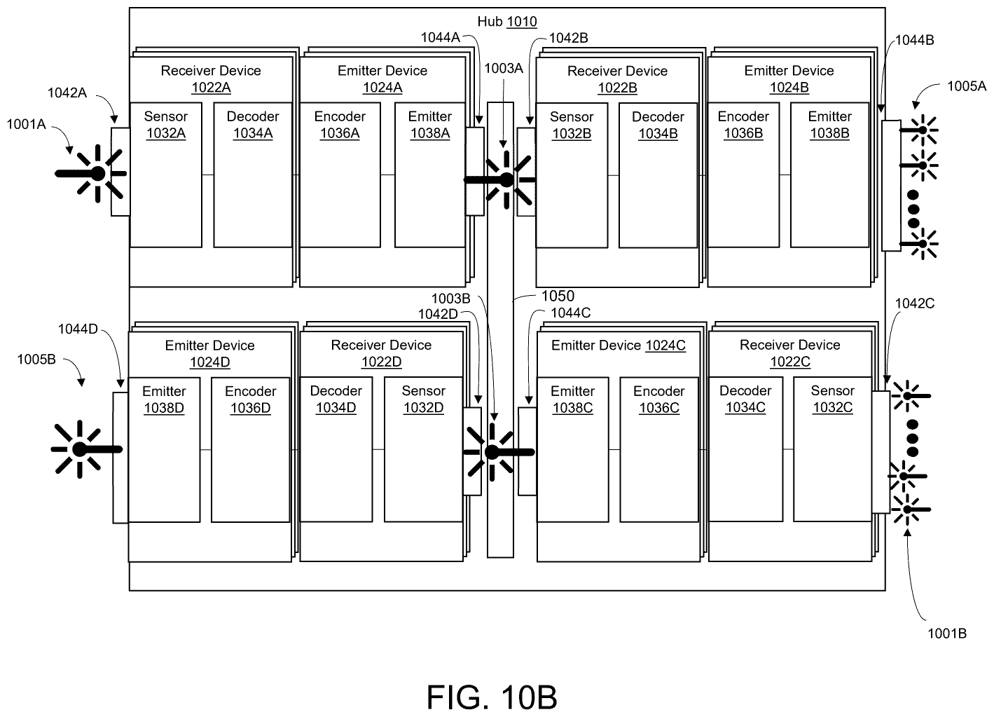

FIG. 10A is a block diagram illustrating an example repeater hub 1010, in accordance with one or more embodiments. The hub 1010 includes n first receiver device(s) 1022A, n first emitter device(s) 1024A, n second receiver device(s) 1022B, and n second emitter device(s) 1024B. The first receiver device(s) 1022A, the first emitter device(s) 1024A, the second receiver device(s) 1022B, and the second emitter device(s) 1024B form first transmission channel(s) for receiving n laser pulse(s) and transmitting n laser pulse(s) in a first transmission direction.

Each of the n first receiver device(s) 1022A includes a first sensor 1032A for receiving a first laser pulse 1001A and a first decoder 1034A for decoding the first laser pulse 1001A. Each of the n first receiver device(s) 1022A can include a filter 1042A (e.g., a diffractor) through which the first laser pulse 1001A may pass (e.g., for pre-processing). Each of the n first emitter device(s) 1024A includes a first encoder 1036A for encoding the decoded data from the first receiver device 1022A into second laser pulse attributes and a first emitter 1038A for generating a second laser pulse 1003A having the second laser pulse attributes. Each of the n first emitter device(s) 1024A can include a filter 1044A (e.g., a diffractor) through which may pass (e.g., for post-processing) the second laser pulse 1003A generated by the first emitter 1038A. FIG. 10A depicts a lone second laser pulse 1003A generated per each of the n first emitters 1038A passing through the filter 1044, and in other embodiments the filter 1044 may split the second laser pulse 1003A into a plurality of laser pulses.

The second laser pulse 1003A may also pass through (e.g., for processing) a processing device 1050. The processing device 1050 can be a dedicated and/or special purpose processing device for processing encoded data of the second laser pulse 1003A. In some embodiments, the processing device 1050 may perform operations on or based on the second laser pulse 1003A. The processing device 1050 may split or otherwise divide second laser pulse 1003A.

Each of the n second receiver device(s) 1022B includes a second sensor 1032B for receiving the second laser pulse 1003A and a second decoder 1034B for decoding the second laser pulse 1003A. Each of the n second receiver device(s) 1022B can include a filter 1042B (e.g., a diffractor) through which the second laser pulse 1003A may pass (e.g., for pre-processing). Each of the n second emitter device(s) 1024B includes a second encoder 1036B for encoding the decoded data from the second receiver device 1022B into third laser pulse attributes and a second emitter 1038B for generating third laser pulse(s) 1005A having the third laser pulse attributes. Each of the n second emitter device(s) 1024B can include a filter 1044B (e.g., a diffractor) through which may pass (e.g., for post-processing) the third laser pulse(s) 1005A generated by the second emitter 1038B. As illustrated, the second emitter 1038A of each of the n second emitter devices 1024B of the repeater hub 1010 of FIG. 10A can emit a plurality (e.g. n) third laser pulses 1005A.

The hub 1010 can be two-directional, and therefore can also include n third receiver device(s) 1022C, n third emitter device(s) 1024C, n fourth receiver device(s) 1022D, and n fourth emitter device(s) 1024D. The third receiver device(s) 1022C, the third emitter device(s) 1024C, the fourth receiver device(s) 1022D, and the fourth emitter device(s) 1024D form second transmission channel(s) for receiving n laser pulse(s) and transmitting n laser pulse(s) in a second transmission direction.

Each of the n third receiver device(s) 1022C includes a third sensor 1032C for receiving a fourth laser pulse 1001B and a third decoder 1034C for decoding the fourth laser pulse 1001B. Each of the n third receiver device(s) 1022C can include a filter 1042C (e.g., a diffractor) through which the fourth laser pulse 1001B may pass (e.g., for pre-processing). Each of the n third emitter device(s) 1024C includes a third encoder 1036C for encoding the decoded data from the third receiver device 1022C into fifth laser pulse attributes and a third emitter 1038A for generating a fifth laser pulse 1003B having the fifth laser pulse attributes. Each of the n third emitter device(s) 1024C can include a filter 1044C (e.g., a diffractor) through which may pass (e.g., for post-processing) the fifth laser pulse 1003B generated by the third emitter 1038C. FIG. 10A depicts a lone fifth laser pulse 1003B generated per each of the n first emitters 1038A. In other embodiments the filter 1044 may split the fifth laser pulse 1003B into a plurality of laser pulses.

The fifth laser pulse 1003B may also pass through (e.g., for processing) the processing device 1050. In some embodiments, the processing device 1050 may perform operations on or based on the fifth laser pulse 1003B. The processing device 1050 may split or otherwise divide fifth laser pulse 1003B.

Each of the n fourth receiver device(s) 1022D includes a fourth sensor 1032B for receiving the fifth laser pulse 1003B and a fourth decoder 1034B for decoding the fifth laser pulse 1003B. Each of the n fourth receiver device(s) 1022D can include a filter 1042B (e.g., a diffractor) through which the fifth laser pulse 1003B may pass (e.g., for pre-processing). Each of the n fourth emitter device(s) 1024D includes a fourth encoder 1036B for encoding the decoded data from the fourth receiver device 1022D into third laser pulse attributes and a fourth emitter 1038B for generating sixth laser pulse(s) 1005B having the third laser pulse attributes. Each of the n fourth emitter device(s) 1024D can include a filter 1044B (e.g., a diffractor) through which may pass (e.g., for post-processing) the sixth laser pulse(s) 1005B generated by the fourth emitter 1038B. As illustrated, each emitter 1038D of the n fourth emitter devices 1024D can emit a plurality of (e.g. n) sixth laser pulses 1005B.

FIG. 10B is a block diagram illustrating an example repeater hub 1010, in accordance with one or more embodiments. The repeater hub 1010 is similar to the repeater hub 1010 of FIG. 10A, but illustrates that a plurality of fourth laser pulses 1001B can be received by the third receiver device 1022C and illustrate that lone sixth laser pulses 1005B can be emitted by the emitter 1038D of each of the n fourth emitter device(s) 1024D.

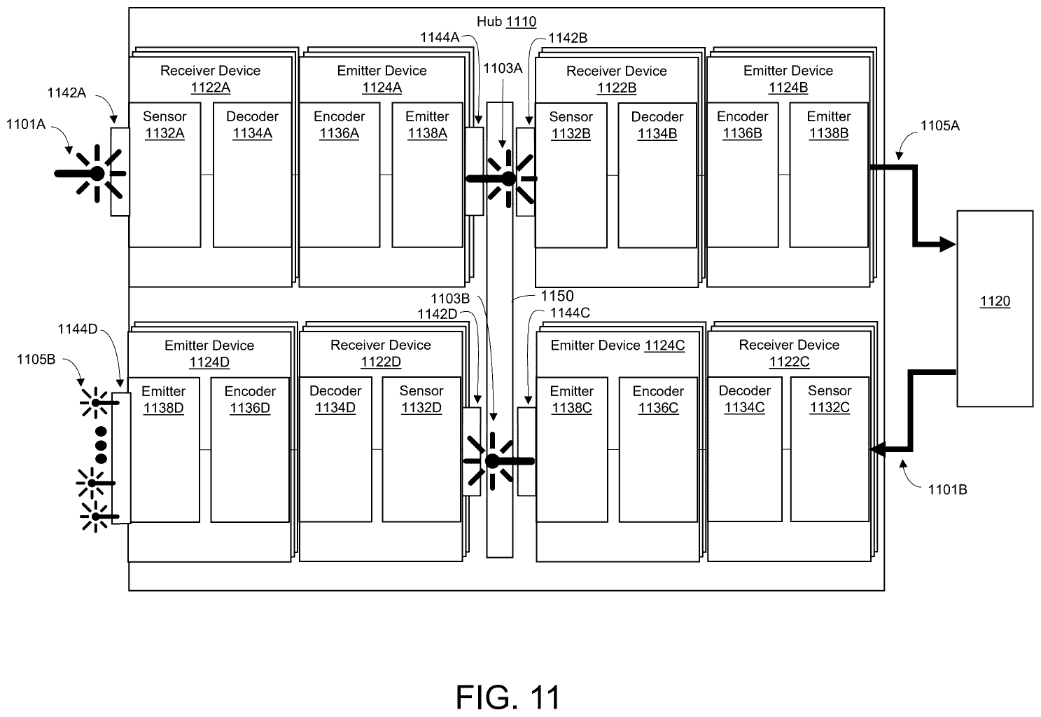

FIG. 11 is a block diagram illustrating an example destination hub 1110, in accordance with one or more embodiments. The destination hub 1110 can couple to and/or communicate with a computing device and/or a computing system 1120 (e.g., at a data center) or otherwise couple to and transmit along a wired connection or other connection that is other than a laser pulse.

The hub 1110 includes n first receiver device(s) 1122A, n first emitter device(s) 1124A, n second receiver device(s) 1122B, and n second emitter device(s) 1124B. The first receiver device(s) 1122A, the first emitter device(s) 1124A, the second receiver device(s) 1122B, and the second emitter device(s) 1124B form first transmission channel(s) for receiving n laser pulse(s) and transmitting in a first transmission direction.

Each of the n first receiver device(s) 1122A includes a first sensor 1132A for receiving a first laser pulse 1101A and a first decoder 1134A for decoding the first laser pulse 1101A. Each of the n first receiver device(s) 1122A can include a filter 1142A (e.g., a diffractor) through which the first laser pulse 1101A may pass (e.g., for pre-processing). Each of the n first emitter device(s) 1124A includes a first encoder 1136A for encoding the decoded data from the first receiver device 1122A into second laser pulse attributes and a first emitter 1138A for generating a second laser pulse 1103A having the second laser pulse attributes. Each of the n first emitter device(s) 1124A can include a filter 1144A (e.g., a diffractor) through which may pass (e.g., for post-processing) the second laser pulse 1103A generated by the first emitter 1138A. FIG. 11 depicts a lone second laser pulse 1103A generated per each of the n first emitters 1138A passing through the filter 1144, and in other embodiments the filter 1144 may split the second laser pulse 1103A into a plurality of laser pulses.

The second laser pulse 1103A may also pass through (e.g., for processing) a processing device 1150. The processing device 1150 can be a dedicated and/or special purpose processing device for processing encoded data of the second laser pulse 1103A. In some embodiments, the processing device 1150 may perform operations on or based on the second laser pulse 1103A. The processing device 1150 may split or otherwise divide second laser pulse 1103A.

Each of the n second receiver device(s) 1122B includes a second sensor 1132B for receiving the second laser pulse 1103A and a second decoder 1134B for decoding the second laser pulse 1103A. Each of the n second receiver device(s) 1122B can include a filter 1142B (e.g., a diffractor) through which the second laser pulse 1103A may pass (e.g., for pre-processing). Each of the n second emitter device(s) 1124B includes a second encoder 1136B for encoding the decoded data from the second receiver device 1122B into wired communication protocol attributes and a second emitter 1138B for generating one or more output wired communication signal(s) 1105A having the wired communication protocol attributes. The second emitter 1038A of each of the n second emitter devices 1024B of the repeater hub 1110 of FIG. 11 can emit a one or more (e.g. n) wired communication signal(s) 1105A, each of which may be received by a computing device of the computing system 1120. In some embodiments, each wired communication signal 1105A can be processed by one or more computing devices.

The computing system 1120 can also provide one or more (e.g. n) input wired communication signal(s) 1101B. Each of the one or more (e.g. n) input wired communication signal(s) 1101B may be provided by a computing device of the computing system 1120.

The hub 1110 can include n third receiver device(s) 1122C, n third emitter device(s) 1124C, n fourth receiver device(s) 1122D, and n fourth emitter device(s) 1124D. The third receiver device(s) 1122C, the third emitter device(s) 1124C, the fourth receiver device(s) 1122D, and the fourth emitter device(s) 1124D form second transmission channel(s) for receiving the one or more (e.g. n) input wired communication signal(s) 1101B and transmitting in a second transmission direction.

Each of the n third receiver device(s) 1122C includes a third sensor 1132C for receiving the input wired communication signal(s) 1101B and a third decoder 1134C for decoding the input wired communication signal(s) 1101B. Each of the n third emitter device(s) 1124C includes a third encoder 1136C for encoding the decoded data from the third receiver device 1122C into fifth laser pulse attributes and a third emitter 1138A for generating a fifth laser pulse 1103B having the fifth laser pulse attributes. Each of the n third emitter device(s) 1124C can include a filter 1144C (e.g., a diffractor) through which may pass (e.g., for post-processing) the fifth laser pulse 1103B generated by the third emitter 1138C. FIG. 11 depicts a lone fifth laser pulse 1103B generated per each of the n first emitters 1138A. In other embodiments the filter 1144 may split the fifth laser pulse 1103B into a plurality of laser pulses.

The fifth laser pulse 1103B may also pass through (e.g., for processing) the processing device 1150. In some embodiments, the processing device 1150 may perform operations on or based on the fifth laser pulse 1103B. The processing device 1150 may split or otherwise divide fifth laser pulse 1103B.

Each of the n fourth receiver device(s) 1122D includes a fourth sensor 1132B for receiving the fifth laser pulse 1103B and a fourth decoder 1134B for decoding the fifth laser pulse 1103B. Each of the n fourth receiver device(s) 1122D can include a filter 1142B (e.g., a diffractor) through which the fifth laser pulse 1103B may pass (e.g., for pre-processing). Each of the n fourth emitter device(s) 1124D includes a fourth encoder 1136B for encoding the decoded data from the fourth receiver device 1122D into third laser pulse attributes and a fourth emitter 1138B for generating sixth laser pulse(s) 1105B having the third laser pulse attributes. Each of the n fourth emitter device(s) 1124D can include a filter 1144B (e.g., a diffractor) through which may pass (e.g., for post-processing) the sixth laser pulse(s) 1105B generated by the fourth emitter 1138B. As illustrated, each emitter 1138D of the n fourth emitter devices 1124D can emit a plurality of (e.g. n) sixth laser pulses 1105B.

In an illustrative embodiment, any of the operations described herein can be implemented at least in part as computer-readable instructions stored on a computer-readable medium or memory. Upon execution of the computer-readable instructions by a processor, the computer-readable instructions can cause a computing device to perform the operations.

### Examples

The following are non-limiting examples of embodiments of the present disclosure.

Example 1. An apparatus comprising: a receiver configured to receive digital data; an encoder configured to determine a color and at least one additional attribute of a laser pulse based on the digital data, the color and the at least one additional attribute corresponding to a content of the digital data; and an emitter configured to generate the laser pulse having the color and the at least one additional attribute.

Example 2. The apparatus of Example 1, wherein the receiver comprises a fiber-optic receiver configured to receive an infrared signal including the digital data.

Example 3. The apparatus of Example 1, wherein the at least one additional attribute includes one or more of a polarization, an intensity, a duration, a pulse shape, a cross-section, a power, an energy, an energy density, a coherence length, a beam profile, and a divergence.

Example 4. The apparatus of Example 1, wherein the encoder is further configured to determine, based on the digital data, a number of the at least one additional attribute to adjust from default values.

Example 5. The apparatus of Example 4, wherein the encoder is further configured to determine a second color and at least one second additional attribute of a second laser pulse corresponding to the content of the digital data, wherein a second number of the at least one second additional attributes is less than the number of the at least one additional attribute.

Example 6. The apparatus of Example 1, wherein the encoder is further configured to determine the color and the at least one additional attribute by using an encryption library to map the content of the digital data to the color and the at least one additional attribute.

Example 7. The apparatus of Example 6, wherein the encoder is further configured to select the encryption library based on a recipient of the laser pulse.

Example 8. An apparatus comprising: one or more sensors configured to determine a color and at least one additional attribute of a laser pulse, the color and the at least one additional attribute corresponding to a content of a message; and a decoder configured to use an encryption library to determine, based on the color and the at least one additional attribute of the laser pulse, the content of the message.

Example 9. The apparatus of Example 8, wherein the decoder is further configured to output a digital signal comprising the content of the message.

Example 10. The apparatus of Example 8, wherein the at least one additional attribute includes one or more of a polarization, an intensity, a duration, a pulse shape, a cross-section, a power, an energy, an energy density, a coherence length, a beam profile, and a divergence.

Example 11. The apparatus of Example 8, wherein the decoder is further configured to determine, based on a comparison of the at least one additional attribute and a set of default values, a number of the at least one additional attribute corresponding to the content of the message.

Example 12. The apparatus of Example 8, wherein the decoder is configured to use the encryption library to map the color and the at least one additional attribute to the content of the message.

Example 13. The apparatus of Example 12, wherein the color corresponds to a starting point in the encryption library, and wherein the at least one additional attribute corresponds to a modification of the starting point in the encryption library.

Example 14. A system comprising: an emitter device comprising: an encoder configured to determine a color and at least one additional attribute of a laser pulse based on digital data, the color and the at least one additional attribute corresponding to a content of the digital data; and an emitter configured to generate the laser pulse having the color and the at least one additional attribute; and a receiver device comprising: one or more sensors configured to determine the color and the at least one additional attribute of the laser pulse, the color and the at least one additional attribute corresponding to a content of a message, the content of the message corresponding to a portion of the content of the digital data; and a decoder configured to use an encryption library to determine, based on the color and the at least one additional attribute of the laser pulse, the content of the message.

Example 15. The system of Example 14, wherein the emitter apparatus further comprises a receiver configured to receive the digital data, and wherein the receiver device is configured to output a digital signal including the content of the message.

Example 16. The system of Example 14, wherein the encoder determines the color and the at least one additional attribute by mapping the content of the digital data to the color and the at least one additional attribute using the encryption library.

Example 17. The system of Example 16, wherein the emitter device includes a second non-transitory, computer-readable medium including the encryption library, and wherein the non-transitory, computer-readable medium includes a set of encryption libraries including the encryption library, and wherein the encoder is configured to select the encryption library from the set of encryption libraries based on the receiver device being a recipient of the laser pulse.

Example 18. The system of Example 14, wherein the encoder is further configured to determine the content of the message based on the receiver device being a recipient of the laser pulse.

Example 19, The system of Example 14, wherein the encoder is further configured to determine a second color and at least one second additional attribute of a second laser pulse corresponding to the content of the digital data, wherein a content of a second message encoded in the second laser pulse is different from the content of the message.

Example 20. The system of Example 14, wherein the at least one additional attribute includes one or more of a polarization, an intensity, a duration, a pulse shape, a cross-section, a power, an energy, an energy density, a coherence length, a beam profile, and a divergence.

Example 21. A method for transmitting digital data using a laser pulse, comprising: receiving digital data at an emitter device; determining, by an encoder of the emitter device, a color and at least one additional attribute of a laser pulse based on the digital data, wherein the color and the at least one additional attribute correspond to a content of the digital data; generating, by the emitter device, the laser pulse having the color and the at least one additional attribute; transmitting the laser pulse to a receiver device; receiving, by one or more sensors of the receiver device, the laser pulse; determining, by the one or more sensors, the color and the at least one additional attribute of the received laser pulse; decoding, by a decoder of the receiver device, the color and the at least one additional attribute using an encryption library to obtain a message corresponding to a portion of the digital data.

Example 22. The method of Example 21, wherein the at least one additional attribute comprises one or more of: polarization, intensity, duration, pulse shape, cross-section, power, energy, energy density, coherence length, beam profile, and divergence.

Example 23. The method of Example 21, wherein the encoder uses a contextual encryption library to map the digital data to the color and the at least one additional attribute.

Example 24. The method of Example 23, wherein the encryption library is selected based on an identifier of the intended recipient of the laser pulse.

Example 25. The method of Example 21, wherein the receiver device compares the at least one additional attribute to a set of default values to determine which attributes encode information.

Example 26. The method of Example 21, wherein the color corresponds to a starting point in the encryption library and the at least one additional attribute corresponds to a sequence of modifications to the starting point to decode the message.

Example 27. The method of Example 21, further comprising generating a second laser pulse based on the same digital data, wherein the second laser pulse encodes a different level of detail using a different number of attributes.

Example 28. The method of Example 21, wherein the laser pulse is transmitted through open air.

Example 29. The method of Example 21, wherein the laser pulse is transmitted through a fiber optic network.

Example 30. The method of Example 21, further comprising re-encoding, by the encoder of the emitter device, a second color and at least one additional attribute of a second laser pulse based on the digital data, wherein the second color and the at least one additional attribute correspond to a content of the digital data; and transmitting the second laser pulse to a plurality of receiver devices.

Example 31. A method for communicating digital data using a laser pulse, comprising: receiving digital data at an emitter device; determining, by an encoder of the emitter device, a color and at least one additional attribute of a laser pulse based on the digital data, wherein the color and the at least one additional attribute correspond to a content of the digital data; generating, by the emitter device, the laser pulse having the color and the at least one additional attribute; and transmitting the laser pulse to a receiver device.

Example 32. A method for communicating digital data using a laser pulse, comprising: receiving, by one or more sensors of a receiver device, a laser pulse; determining, by the one or more sensors, a color and at least one additional attribute of the received laser pulse; and decoding, by a decoder of the receiver device, the color and the at least one additional attribute using an encryption library to obtain a message corresponding to a portion of the digital data.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. An apparatus comprising:
a receiver configured to receive digital data;
an encoder configured to determine a color and at least one additional attribute of a laser pulse based on the digital data, the color and the at least one additional attribute corresponding to a content of the digital data; and
an emitter configured to generate the laser pulse having the color and the at least one additional attribute.

2. The apparatus of claim 1, wherein the receiver comprises a fiber-optic receiver configured to receive an infrared signal including the digital data.

3. The apparatus of claim 1, wherein the at least one additional attribute includes one or more of a polarization, an intensity, a duration, a pulse shape, a cross-section, a power, an energy, an energy density, a coherence length, a beam profile, and a divergence.

4. The apparatus of claim 1, wherein the encoder is further configured to determine, based on the digital data, a number of the at least one additional attribute to adjust from default values.

5. The apparatus of claim 4, wherein the encoder is further configured to determine a second color and at least one second additional attribute of a second laser pulse corresponding to the content of the digital data, wherein a second number of the at least one second additional attribute is less than the number of the at least one additional attribute.

6. The apparatus of claim 1, wherein the encoder is further configured to determine the color and the at least one additional attribute by using an encryption library to map the content of the digital data to the color and the at least one additional attribute.

7. The apparatus of claim 6, wherein the encoder is further configured to select the encryption library based on a recipient of the laser pulse.

8. An apparatus comprising:
one or more sensors configured to determine a color and at least one additional attribute of a laser pulse, the color and the at least one additional attribute corresponding to a content of a message; and
a decoder configured to use an encryption library to determine, based on the color and the at least one additional attribute of the laser pulse, the content of the message.

9. The apparatus of claim 8, wherein the decoder is further configured to output a digital signal comprising the content of the message.

10. The apparatus of claim 8, wherein the at least one additional attribute includes one or more of a polarization, an intensity, a duration, a pulse shape, a cross-section, a power, an energy, an energy density, a coherence length, a beam profile, and a divergence.

11. The apparatus of claim 8, wherein the decoder is further configured to determine, based on a comparison of the at least one additional attribute and a set of default values, a number of the at least one additional attribute corresponding to the content of the message.

12. The apparatus of claim 8, wherein the decoder is configured to use the encryption library to map the color and the at least one additional attribute to the content of the message.

13. The apparatus of claim 12, wherein the color corresponds to a starting point in the encryption library, and wherein the at least one additional attribute corresponds to a modification of the starting point in the encryption library.

14. A system comprising:
an emitter device comprising:
an encoder configured to determine a color and at least one additional attribute of a laser pulse based on digital data, the color and the at least one additional attribute corresponding to a content of the digital data; and
an emitter configured to generate the laser pulse having the color and the at least one additional attribute; and
a receiver device comprising:
one or more sensors configured to determine the color and the at least one additional attribute of the laser pulse, the color and the at least one additional attribute corresponding to a content of a message, the content of the message corresponding to a portion of the content of the digital data; and
a decoder configured to use an encryption library to determine, based on the color and the at least one additional attribute of the laser pulse, the content of the message.

15. The system of claim 14, wherein the emitter apparatus further comprises a receiver configured to receive the digital data, and wherein the receiver device is configured to output a digital signal including the content of the message.

16. The system of claim 14, wherein the encoder determines the color and the at least one additional attribute by mapping the content of the digital data to the color and the at least one additional attribute using the encryption library.

17. The system of claim 16, wherein the emitter device includes a second non-transitory, computer-readable medium including the encryption library, and wherein the non-transitory, computer-readable medium includes a set of encryption libraries including the encryption library, and wherein the encoder is configured to select the encryption library from the set of encryption libraries based on the receiver device being a recipient of the laser pulse.

18. The system of claim 14, wherein the encoder is further configured to determine the content of the message based on the receiver device being a recipient of the laser pulse.

19. The system of claim 14, wherein the encoder is further configured to determine a second color and at least one second additional attribute of a second laser pulse corresponding to the content of the digital data, wherein a content of a second message encoded in the second laser pulse is different from the content of the message.

20. The system of claim 14, wherein the at least one additional attribute includes one or more of a polarization, an intensity, a duration, a pulse shape, a cross-section, a power, an energy, an energy density, a coherence length, a beam profile, and a divergence.
